(19) United States
(12) Patent Application Publication
(10) Pub. No.: US 2008/0098361 A1
(43) Pub. Date: Apr. 24, 2008

(54) METHOD AND APPARATUS FOR FILTERING SOFTWARE TESTS

(76) Inventors: Ashish Kumar, Fremont, CA (US); Robert Scott Vachalek, Cupertino, CA (US)

Correspondence Address: PARK, VAUGHAN & FLEMING LLP, 2820 FIFTH STREET, DAVIS, CA, 95618-7759, US

(21) Appl. No.: 11/768,397

(22) Filed: Jun. 26, 2007

Related U.S. Application Data
(60) Provisional application No. 60/853,204, filed on Oct. 20, 2006.

(51) Int. Cl. G06F 11/36; G06F 9/44

(52) U.S. Cl. 717/128

(57) ABSTRACT

Embodiments of the present invention provide a system that generates a test for a class under test. The system first receives an operation sequence to be applied to the class under test. The system then generates one or more operation subsequences from the received operation sequence. Next, the system filters each operation subsequence. The system then produces a filtered version of the operation subsequences, wherein the filtered version of the operating subsequences can be used to perform tests on the class under test more expediently.

### RELATED APPLICATION

This application hereby claims priority under 35 U.S.C. §119(e) to U.S. Provisional Application Ser. No. 60/853,204, filed on 20 Oct. 2006, the contents of which are herein incorporated by reference.

### BACKGROUND

1. Field of the Invention

Embodiments of the present invention relate to techniques for testing software. More specifically, embodiments of the present invention relate to a technique for filtering sequences of operations to produce targeted software tests.

2. Related Art

Software testing is a critical part of the software development process. As software is written, the software is typically subjected to an extensive battery of tests which ensure that the software operates properly. It is far preferable to fix bugs in code modules as they are written, to avoid the cost and frustration of dealing with them during large-scale system tests, or even worse, after software is deployed to end-users.

As software systems grow larger and more complicated, creating a set of tests that adequately exercise the software systems is becoming harder. The creation of a set of tests is difficult because the tester has to create test cases to cover all of the possible combinations of input parameters and initial system states that the system may encounter during operation. Consequently, the amount of test code required to cover the possible combinations is typically a multiple of the number of instructions in the code under test.

One of the challenges in creating tests for program code is to produce a sequence of operations (a “testing sequence”) that thoroughly exercises the code under test. Unfortunately, creating a testing sequence by hand, particularly for anything other than the very smallest bodies of program code, is often virtually impossible. Hence, it is desirable to generate the testing sequence automatically. However, simple automated test generators can produce extremely large testing sequences which, although they exercise a large percentage of the paths in the code, can require large amounts of time and computational resources to execute.

These testing sequences typically include a significant number of operations that are superfluous or redundant. Consequently, a significant percentage of the execution time for the testing sequence may be spent executing operations which provide no unique information about the correctness of the underlying program code.

Hence, what is needed is a method and apparatus for limiting the size of software testing sequences to the minimal necessary operations.

### SUMMARY

Embodiments of the present invention provide a system that generates a test for a class under test. The system first receives an operation sequence to be applied to the class under test. The system then generates one or more operation subsequences from the received operation sequence. Next, the system filters each operation subsequence. The system then produces a filtered version of the operation subsequences, wherein the filtered version of the operating subsequences can be used to perform tests on the class under test more expediently.

In some embodiments, when receiving the operation sequence, the system receives a sequence of operations generated from program code, wherein the sequence of operations includes operations performed on at least one path through the program code.

In some embodiments, when receiving the operation sequence, the system prepares the operation sequence by: (1) recording operations in the operating sequence that are performed on the class under test as potential test calls; (2) instrumenting the class under test; and (3) executing the operation sequence and storing information related to each potential test call in a variable associated with the potential test call.

In some embodiments, when instrumenting the class under test, the system adds one or more calls to the class under test, wherein the calls record information related to the execution of the class under test.

In some embodiments, when generating one or more operation subsequences from the received operation sequence, the system generates an operation subsequence for each potential test call, wherein each operation subsequence includes a copy of the operations between the start of the operation sequence and the corresponding potential test call.

In some embodiments, filtering each operation subsequence involves pre-filtering the operation subsequence by: (1) removing setup calls from the operating subsequence when the setup calls have undesirable effects on the potential test call; (2) removing unused objects; (3) removing unrelated objects; (4) removing operations that do not produce objects or alter state from the operation subsequence; and/or (5) removing intermediate states.

In some embodiments, after pre-filtering is completed, the system discards operation subsequences that include more than a predetermined number of operations. Next, for operation sequences that are not discarded, the system verifies that the potential test call at the end of the operating subsequence produces the same results as the information stored in the variable associated with the potential test call.

In some embodiments, the system discards the operating subsequence if the potential test call at the end of the operating subsequence does not produce the same results.

In some embodiments, the system saves the operation subsequence as a unique operating subsequence if the potential test call at the end of the operating subsequence produces different but unique results, wherein the unique operating subsequence can subsequently be used as another test for the class under test.

In some embodiments, if the potential test call at the end of the operating subsequence produces the same results, the system post-filters the operation subsequence by: (1) replacing with equivalent mock objects objects that cannot be constructed due to missing operations and/or objects of any class that has consistency problems due to timing or environmental dependencies from the subsequence; (2) removing unnecessary operations; (3) normalizing data, values and/or construction sequences; and/or (4) removing unnecessary instances of objects.

In some embodiments, when filtering the operation subsequence, the system post-filters the operation subsequence by: (1) replacing with equivalent mock objects objects that cannot be constructed due to missing operations and/or objects of any class that has consistency problems due to timing or environmental dependencies from the subsequence; (2) removing unnecessary operations; (3) normalizing data, values and/or construction sequences; and/or (4) removing unnecessary instances of objects.

In some embodiments, when producing the filtered version of the operating subsequences, the system produces the filtered version of the operating subsequence in a common programming language.

In some embodiments, the system performs the test on the class under test using the filtered operation subsequences.

### BRIEF DESCRIPTION OF THE FIGURES

FIG. 1 presents a block diagram of a computer system in accordance with embodiments of the present invention.

FIG. 2 presents a flowchart illustrating the process of generating a set of tests in accordance with embodiments of the present invention.

FIG. 3 presents a flowchart illustrating the process of preparing the operation sequence in accordance with embodiments of the present invention.

FIG. 4 presents an operation sequence and two reduced operation sequences in accordance with embodiments of the present invention.

FIG. 5 presents a flowchart illustrating the process of pre-filtering an operation sequence in accordance with embodiments of the present invention.

FIG. 6 presents a flowchart illustrating a process of verifying the pre-filtered operation sequence in accordance with embodiments of the present invention.

FIG. 7 presents a flowchart illustrating the process of post-filtering the operation sequence in accordance with embodiments of the present invention.

Table 1 presents a table of operation terms in accordance with embodiments of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

The data structures and code described in this detailed description are typically stored on a computer-readable storage medium, which may be any device or medium that can store code and/or data for use by a computer system. This includes, but is not limited to, magnetic and optical storage devices, such as disk drives, magnetic tape, CDs (compact discs) and DVDs (digital versatile discs or digital video discs), or solid-state devices, such as flash memory, or other volatile and non-volatile storage media.

### Terminology

We use the following terminology in addition to standard object-oriented programming terminology.

Atomic Type: The atomic type includes objects such as primitive values (int, char, double, etc.) and arrays. However, for our purposes, any class that is easily constructed and produces immutable, equivalent objects can be considered atomic because source code to create the object can be generated at will. Therefore, we consider all primitives and primitive wrapper classes (i.e., java.lang.integer) to be atomic as well as java.lang.String and java.lang.Class.

Object Reference: A class that represents a unique reference to another object. For atomic types the object reference embeds the value. For others, the object reference records the type of the object as well as the object's identity hash code (as returned from System.identityHashCode( )).

Operation: A single action in a sequence. Operations include method and constructor calls, but also include instructions, field accesses and mutations, and all array operations (create, access, and mutate). An operation includes a symbolic representation of the operation (“call method String.append( )” or “get field System.out”) as well as any arguments and/or parameters necessary to perform the operation represented as object references.

Operation Sequence: A series of operations, executed in order.

Setup Sequence: An operation sequence executed in order to establish the preconditions necessary for the test.

Test Call: An operation identified as the target for a test. The test call is a method or constructor call made on the class under test.

Setup Operation: An operation is a setup operation if the operation is not the test call for a particular test. An operation can be a setup operation for one test, and be the test call for another test.

Mock Object: An object that is declared to be the same type as a real object used in the test (by implementing the same interfaces or extending the necessary base class) but is missing the logic necessary to act as that type. Instead, the mock object is programmed by the setup sequence to respond in a predetermined way for testing purposes. Mock objects can be used in unit testing frameworks to simulate certain conditions, improve performance, or isolate failures.

### Overview

Given any operation sequence and a class under test, some embodiments of the present invention reduce the operation sequence to a set of “tests” that demonstrate unique specifications for the class under test. These embodiments create tests that demonstrate the actual behavior of the operation sequence. In some embodiments, a human observer can identify which of the results of the generated tests reflect defects in the product (i.e., the class under test), and which ones are expected behavior.

There are a number of techniques for generating high quality operation sequences for a class under test. For example, one such technique is described by Marat Boshernitsan, Roongko Doong, and Alberto Savoia in “From Daikon To Agitator: Lessons and Challenges in Building a Commercial Tool for Developer Testing,” Proceedings of the 2006 International Symposium on Software Testing and Analysis, Portland, Me., July 2006. Note that the number and the quality of the tests generated from the operation sequence is related to the coverage and quality of the operation sequence itself.

### Computer System

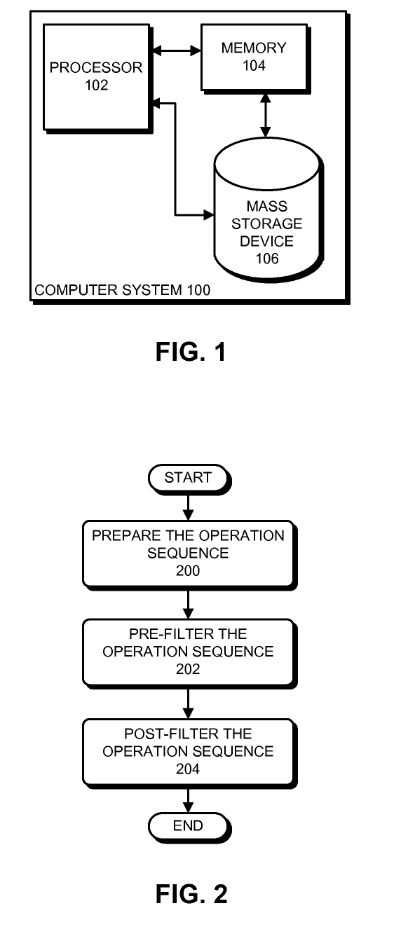

FIG. 1 presents a block diagram of a computer system 100 in accordance with embodiments of the present invention. Computer system 100 includes processor 102, memory 104, and mass storage device 106. In some embodiments of the present invention, computer system 100 is a general-purpose computer that is used to generate a set of tests for a class under test and to execute the set of tests for the class under test.

Processor 102 is a central processing unit (CPU) that processes instructions for computer system 100. For example, processor 102 can be a microprocessor, a controller, an ASIC, or any other type of computational engine. Memory 104 is volatile memory that stores instructions and data for processor 102 during operation of computer system 100. For example, memory 104 can be DRAM, SDRAM, or another form of volatile memory. Mass storage device 106 is a non-volatile storage device that stores instructions and data for processor 102. For example, mass storage device 106 can be a hard disk drive, a flash memory, an optical drive, or another non-volatile storage device.

Note that although we describe embodiments of the present invention using computer system 100, alternative embodiments use other types of computing devices.

### Generating a Set of Tests for A Class Under Test

FIG. 2 presents a flowchart illustrating the process of generating a set of tests in accordance with embodiments of the present invention. As shown in FIG. 2, given a single arbitrarily long operation sequence, the steps in identifying and generating a set of tests that test a particular class's specifications are:
1. Preparing the operation sequence (step 200): which involves recording information about operations.
2. Filtering the operation sequence, which involves:
   a. Pre-filtering the operation sequence (step 202): which reduces the operation sequence using aggressive static filters; and
   b. Post-filtering the operation sequence (step 204): which further reduces the pre-filtered operation sequence using conservative dynamic filters.

These steps are described in more detail below. Note that in some embodiments of the present invention, the system may perform the steps in an order other than the order in which the steps are described, and/or may skip one or more steps (or one or more parts of steps) in the process.

### Preparing the Operation Sequence

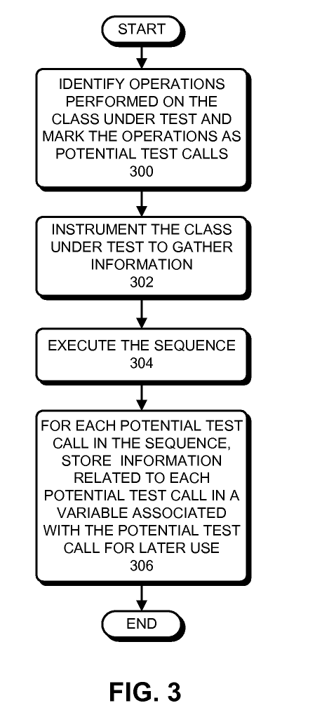

FIG. 3 presents a flowchart illustrating the process of preparing the operation sequence in accordance with embodiments of the present invention. Preparing the operation sequence involves performing the following actions:
1. Identifying operations directly performed on the class under test (CUT) and mark the operations as potential test calls (step 300).
2. Instrumenting the CUT to gather information (step 302). For example, calls can be added before and/or after conditional instructions in methods within the class. Each call can potentially record information about the conditional instruction (e.g., the status of the comparison value(s), the resolution of the conditional, or the type of conditional). In some embodiments, the added calls include the following:
   a. Coverage by branch, which involves inserting a call to record whether a branch was traversed. For instance, each Boolean condition can get two coverage points (i.e., calls), one for true and one for false. In addition, each statement and/or line can get one coverage point.
   b. Boundary conditions, wherein each time a number comparison is performed and one of the sides of the comparison is a constant (e.g., i>500 or s.length ( )==20), the system inserts a call to record the comparison with both the actual left-hand-side (LHS) and right-hand-side (RHS) values. The call can be used to recognize boundary cases. For instance, in the case of i>500, the tests for i==499, 500, and 501 are unique tests that are generated in the final set of tests.

3. Executing the operation sequence (step 304) one operation at a time. In some embodiments of the present invention, the operation sequence can be executed reflectively.

4. During execution, for each ‘potential test call’ in the operation sequence, storing information related to each potential test call in a variable associated with the potential test call for later use (step 306). For example, some embodiments of the present invention can:
a. Record the coverage for the class before and after the test call—to get an understanding of what branches this code covers;
b. Record any boundaries that were exercised by this call (for instance, i=499);
c. Record any unique return values (for instance, if the method returns a collection/array—a collection of size 0 and collection of non-zero size are different); and/or
d. Record any exceptions that the method throws (which can include recording the type of the exception thrown for uniqueness).

Filtering the Operation Sequence

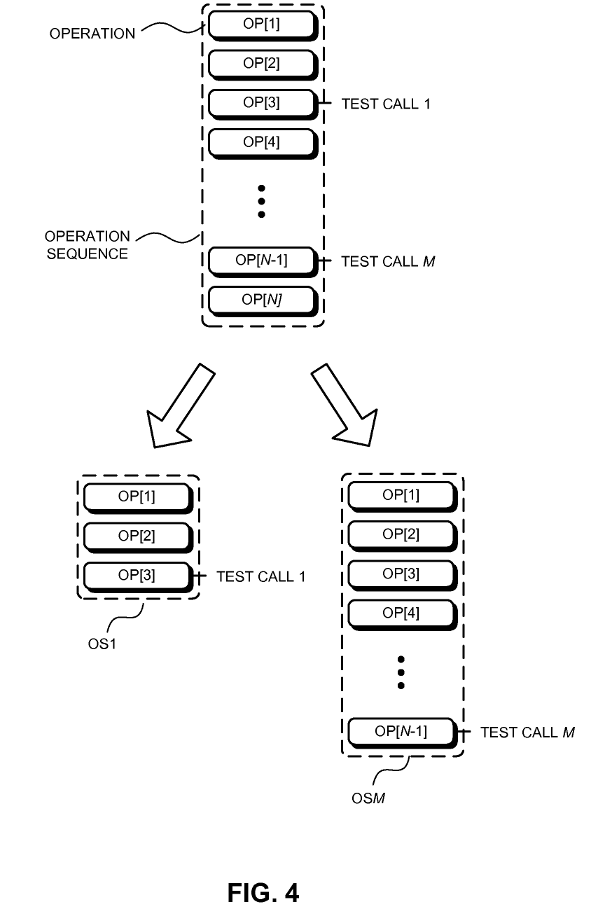

FIG. 4 presents a operation sequence and two reduced operation sequences in accordance with embodiments of the present invention. Given a sequence of 1 . . . n operations (OP[1] . . . OP[n] in the operation sequence), with m test calls, for each test call (at a corresponding position p), filtering involves reducing the original 1 . . . p operation sequence (OS) down to the relevant set of operations. So the input to filtering is m operation sequences with the last operation on each sequence being the test call to which the filtering is related.

Hence, for m test calls, operation sequences OS1 . . . OSm are provided as inputs to the filtering process. Note that OS1 is a subset of OSm, and hence the operations in OS1 are also part of the setup call for OSm. In fact, all calls up to last test call (at the end of the original operation sequence) are considered setup calls for operation sequences related to subsequent test calls.

For each OS(1 . . . m), the following paragraphs describe the steps for filtering the reduced operation sequence down to the necessary set of operations. Note that some embodiments of the present invention perform the filtering steps in a different order and/or skip one or more steps in the filtering process.

Pre-Filtering/Static Filtering

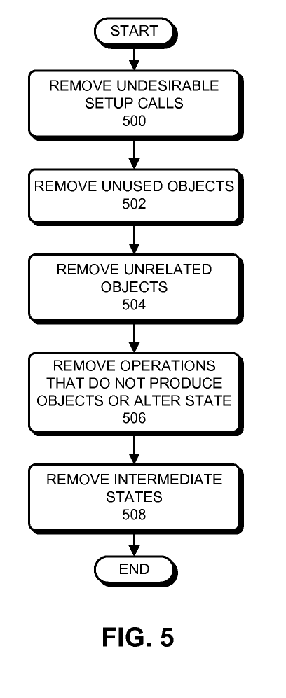

FIG. 5 presents a flowchart illustrating the process of pre-filtering an operation sequence in accordance with embodiments of the present invention. Pre-filtering the operation sequence removes operations from the operation sequence that are not in some way used to perform the test call at the end of the operation sequence.

In some embodiments of the present invention, the following actions are performed iteratively until the actions do not impact the size of the operation sequence (i.e., until no operations are removed from the operation sequence during an iteration). Note that performing the actions iteratively can result in the removal of more operations from the operation sequence, because every time an operation is removed, the removal can affect other operations that were being kept solely to construct the removed operation's parameters.
1. Remove undesirable setup calls (step 500). For example, this action can remove setup calls that throw exceptions, as these setup calls would likely not help getting the desired outcome from the test call. (Note that some embodiments of the present invention can be configured to keep setup calls that throw relevant exceptions.)
2. Remove unused objects (step 502). Remove from the operation sequence any operation that does not: (1) produce a non-atomic object used by other operations, or (2) alter the state of the system in any other way (e.g, by mutating parameters).
   a. To determine if a method could alter the state of the system, we use static analysis of the method related to the operation. In other words, we follow inter-method calls up to 2 classes away from the CUT. For example, if method 1 (M1) in the CUT calls M2 in class 1 (C1), which in turn calls M3 in C2, which calls M4 in C3—our analysis stops with M3 in C2.
   b. Static analysis for mutation of parameters is conservative, so if the calls proceed beyond a predefined “depth” (i.e., M3 in C2 as described above) or if one of the methods in the call chain was native or on an interface that could mutate the parameters, we assume that the call would have mutated the parameters. For example, in the case above, the call to M1 is considered mutating.
   c. Methods that mutate class or instance fields are considered mutating by the static analysis.
3. Remove unrelated objects (step 504). Identify all operations that create non-atomic parameters to the test call, possibly mutate those parameters, or possibly mutate global state. Then identify all operations that create or possibly mutate non-atomic parameters to these operations recursively until a tree of operations is identified. Remove all other operations from the operation sequence.
4. Remove operations that do not produce objects or alter state (step 506). Go back to the operations kept (i.e., not discarded in steps 500-504) for “possibly” mutating state and use static analysis to remove operations which can be guaranteed not to mutate the relevant state.
5. Remove intermediate states (step 508). Of the remaining operations that mutate state, use static analysis to remove operations that contain irrelevant mutations. For example, setting a value to “5” and then to “5” again without an intermediate use of the value is redundant. On the other hand, setting the value to “5” and then to “7” without an intermediate use makes the “5” setting operation irrelevant so only the “7” setting operation needs to be kept. (Note that the value set by these operations may not have an intervening use because one or more operations were removed from between these operations in steps 500-506.)

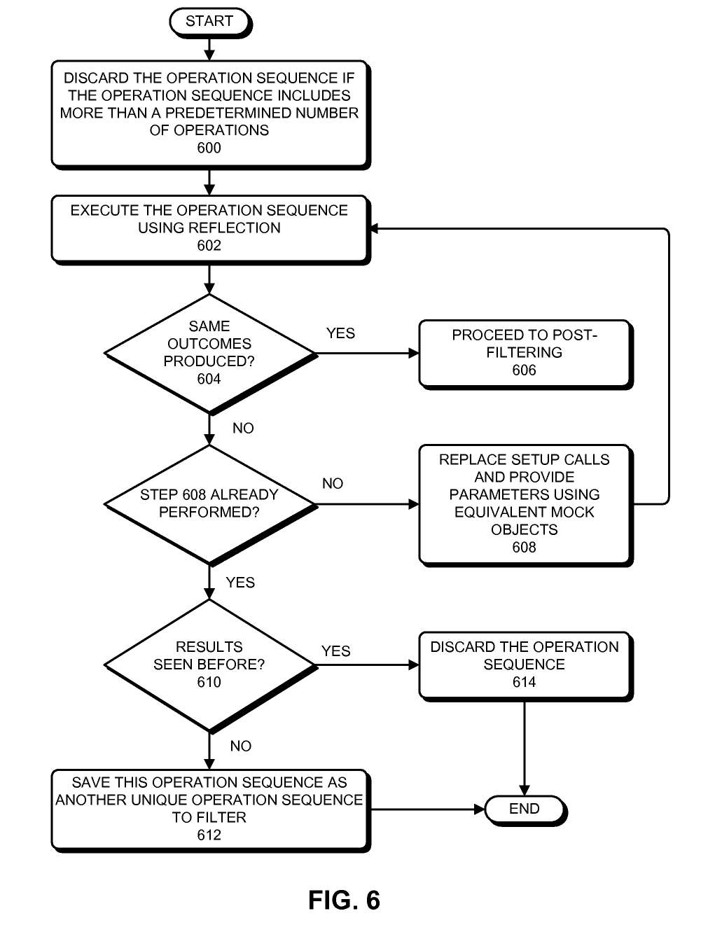

FIG. 6 presents a flowchart illustrating a process of verifying the pre-filtered operation sequence in accordance with embodiments of the present invention. (Note that embodiments of the present invention skip further processing steps for an operation sequence if the operation sequence is discarded.)

The system first discards the pre-filtered operation sequence if the operation sequence includes more than a predetermined number of operations (step 600). For example, if the operation sequence includes over 100 operations, the operation sequence can be discarded because post-filtering/dynamic filtering is too expensive for operation sequences that include more operations.

The system then executes the pre-filtered operation sequence using reflection (step 602) and validates that the test call still produces the same outcome as the unfiltered operation sequence (e.g., coverage, number boundaries, and return value boundaries) (step 604).
1. If the operation sequence performs the same outcome as before, proceed to the post-filtering (step 606).
2. If the operation sequence produces a different outcome:
   a. Unless step 608 has already been performed, replace all setup calls and provide parameters using equivalent mock objects (step 608) and then repeat steps 602-604.
   b. Determine if the results (e.g., coverage, number boundaries, return value boundaries) have been seen before by other test calls in the operation sequence (step 610). If not, save this operation sequence as a unique operation sequence to filter (OS(m+1)) (step 612). If so, discard the operation sequence (step 614).

Assertion Generation

Some embodiments of the present invention subsequently generate assertions on the test call for the operation sequence. For example, one such assertion is the “assert equals” assertion, which is part of common unit testing frameworks. Such unit testing frameworks are known in the art and therefore are not described.

The assertion generation is performed by saving the objects before and after the test call (i.e., during the last reflection-based run of the operation sequence) and performing a nested diff analysis on the pre- and post-object graphs to analyze which objects the test call changed. Assertion generation can include placing assertions to analyze return value(s) and/or exceptions. In the absence of diff and return value assertions, assertions are placed based on statically analyzing what the test call accesses from the class (for instance, GETFIELD or GETSTATIC operations).

Post-Filtering/Dynamic Filtering

After the operation sequence has completed the pre-filtering process, the operation sequence enters post-filtering (interchangeably called “dynamic filtering”). The post-filtering phase eliminates unnecessary operations from the setup sequence that cannot be identified via static filtering techniques and also normalizes the selection of test data in the setup sequence operations.

Each operation sequence that enters post-filtering is ensured, by the earlier checks, to be shorter than a predetermined number of operations (e.g., less than 100 operations) and to produce the desired outcome (i.e., the test call in the pre-filtered operation sequence produces the same result as the test call in the full operation sequence).

In some embodiments of the present invention, during post-processing, the dynamic filters make a change to the setup sequence for a given operation sequence, then execute the setup sequence and test call. For example, the dynamic filters can remove an operation from the given operation sequence and then re-execute the operation sequence. If the test results (e.g., exception, return value, covered path, and boundary conditions) are different, the change is reversed.

In some embodiments of the present invention, if any of these temporary changes result in unique results that are not achieved with any of the existing tests, the operation sequence can be saved as a new test and passed through the filtering process later.

Note that the pre-filtering modified a larger operation sequence, but only executed the operation sequence once (after the pre-filtering was complete). On the other hand, the dynamic filter executes the given sequence multiple times.

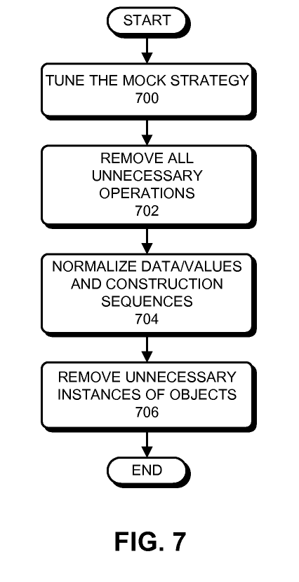

FIG. 7 presents a flowchart illustrating the process of post-filtering the operation sequence in accordance with embodiments of the present invention. The post-filtering/dynamic filtering process includes the following actions:
1. Tune the “mock strategy” (step 700). This involves dynamic filtering (and verification) which uses an adjustable strategy for mock objects that selects when to remove real objects that were used in the original sequence and replace them with equivalent mock objects. Any objects that cannot be constructed due to missing operations are “mocked,” as are objects of any class that is known to have consistency problems due to timing or environmental dependencies. As part of the dynamic filtering process, the mock strategy is adjusted to find a consistently functional sequence using as few mock objects as possible.
2. Remove all unnecessary operations (step 702). During this operation, each independent setup operation is removed, one at a time, to see if the setup operation is actually required to achieve the expected results. In other words, an operation is removed from the operation sequence and the sequence is run. If the results are the same without the removed operation as they were with the removed operation, the operation is discarded from the operation sequence. Otherwise, if the results are different, the result of the operation can be mocked or the operation can be put back into the sequence.
3. Normalize data/values and construction sequences (step 704). For example, some embodiments of the present invention try using canonical numbers such as “100” instead of a unique numbers such as “342” in the operation sequence. Using recognizable numbers improves consistency and readability by not implying significance to a selected value when any value will do. In addition, when a sub-operation sequence is used to construct a particular object, embodiments of the present invention attempt to use the same sub-operation each time the object is constructed (as opposed to using a different sub-operation each time the object is constructed).
4. Remove unnecessary instances of objects (step 706). For example, when an operation takes an object “A” and produces an object “B” of the same type, embodiments of the present invention remove the operation and replace object B with object A.

### Example Class and Resulting Test

The following section provides a “Product” class, some intermediate output from a filtering process on an operation sequence that calls constructors and methods in the Product class, a test call, and an exemplary test in accordance with embodiments of the present invention.

```
package tutorial;
public class Product {
    private static final String CODE_MASK = “[A-Z]-
    \\d\\d\\d\\d-\\d\\d-[A-Z]”;
    private String code;
/*
* @param CODE_MASK Must be of the form A-9999-99-A
* @throws IllegalArgumentException if the code is invalid
*/
public Product(String code) throws IllegalArgumentException{
    validateCode(code);
    this.code = code;
}
public String getCode( ) {
    return code;
}
public String toString( ) {
    return code;
}
private void validateCode(String code) throws
IllegalArgumentException {
    if (!code.matches(CODE_MASK)) {
        throw new IllegalArgumentException(“Product code
        should be of the form A-9999-99-A”);
    }
    if (code == null) {
        throw new IllegalArgumentException(“Product code
        cannot be null”);
    }
}}
```

The Product class has a constructor that takes a product code as an argument. The product code is validated using the regular expression (regex) match in the validateCode method. Unless the product code is invalid, a new Product object is created using the product code. The Product class also includes a method for getting the code of a Product object.

We now present an example operation with a subsequent definition of the terms in the operation. In Java, the operation is:

Product p = new Product(“testString”); // throws
IllegalArgumentException,

and the resulting operation is:

TABLE 1
Operation Terms

#19605997 tutorial/Product.<init>.(Ljava/lang/String;)V
[[ref[java.lang.String:“testString”]]] [ref[NULL]] Ex:
[ref[java.lang.IllegalArgumentException@1c2ec05/notnull]].

| | |
|---|---|
| #19605997 | System.identityHashCode( ) value for |
| | the operation. |
| tutorial/Product.<init> | Indicates that this operation is a |
| | constructor call for the Product |
| | class. |
| (Ljava/lang/String;)V | Indicates that the constructor |
| | which has 1 string parameter is the |
| | one being invoked. |
| [[ref[java.lang.String:“test | Represents the object references |
| String”]]] | for the parameter. (In this case, |
| | all the object references are for |
| | atomic types, hence the values are |
| | embedded in the object references. |
| | So the constructor was invoked with |
| | the code value of “testString.”) |
| [ref[NULL]] Ex: | Represents the return value from |
| [ref[java.lang.IllegalArgume | the call, as well as any exceptions |
| ntException@1c2ec05/notnull] | thrown. In this case the |
| ] | constructor threw an |
| | IllegalArgumentException. ref[NULL] |
| | is a special object reference to |
| | represent a null value. |

The following paragraphs present an example of a simple input operation sequence that is reduced to the final sequence (with comments on the filtered operations showing which filtering step was used to eliminate the operation). The test call is the last operation for ‘Product.toString( ).’ Note that the operations that make it through the filtering processes are accented using bold typeface (and that “filtered” operations are removed from the operation sequence).

/* filtered - setup call throws exceptions - undesirable */
#19605997 tutorial/Product.<init>.(Ljava/lang/String;)V
[[ref[java.lang.String:“testString”]]] [ref[NULL]] Ex:
[ref[java.lang.IllegalArgumentException@1c2ec05/notnull]]
/* filtered - setup call throws exceptions - undesirable */
#13472381 tutorial/Product.<init>.(Ljava/lang/String;)V
[[ref[java.lang.String:“D1”]]] [ref[NULL]] Ex:
[ref[java.lang.IllegalArgumentException@442c76/notnull]]
/* filtered - setup call throws exceptions - undesirable */
#5002799 tutorial/Product.<init>.(Ljava/lang/String;)V
[[ref[java.lang.String:“Product code should be of the form A-
999999-A”]]] [ref[NULL]] Ex:
[ref[java.lang.IllegalArgumentException@16a23cf/notnull]]
/* filtered - setup call throws exceptions - undesirable */
#4018462 tutorial/Product.<init>.(Ljava/lang/String;)V
[[ref[NULL]]] [ref[NULL]] Ex:
[ref[java.lang.NullPointerException@ecf608/notnull]]
/* filtered - setup call throws exceptions - undesirable */
#26780509 tutorial/Product.<init>.(Ljava/lang/String;)V
[[ref[java.lang.String:“”]]] [ref[NULL]] Ex:
[ref[java.lang.IllegalArgumentException@1412b61/notnull]]
/* filtered - setup call throws exceptions - undesirable */
#6610297 tutorial/Product.<init>.(Ljava/lang/String;)V
[[ref[java.lang.String:“?????????????????????????????”]]]
[ref[NULL]] Ex:
[ref[java.lang.IllegalArgumentException@1064a6d/notnull]]
/* not-filtered - setup call produces the ‘this’ object for the
test call */
#11698353 tutorial/Product.<init>.(Ljava/lang/String;)V
[[ref[java.lang.String:“V-3496-55-F”]]]
[ref[tutorial.Product@170a650/notnull]] Ex: [ref[NULL]]
/* filtered - setup call produces an object that's not used by the
test call */
#18817368 tutorial/Product.<init>.(Ljava/lang/String;)V
[[ref[java.lang.String:“H-7858-51-X”]]]
[ref[tutorial.Product@5113f0/notnull]] Ex: [ref[NULL]]
/* filtered - setup call produces an object that's not used by the
test call and doesn't mutate state */
#33371659 tutorial/Product.getCode.( )Ljava/lang/String;
[[ref[tutorial.Product@170a650/notnull]]]
[ref[java.lang.String:“V-3496-55-F”]] Ex: [ref[NULL]]
/* filtered - setup call throws exceptions - undesirable */
#29478849 tutorial/Product.<init>.(Ljava/lang/String;)V
[[ref[java.lang.String:“testString”]]] [ref[NULL]] Ex:
[ref[java.lang.IllegalArgumentException@1bdbf9d/notnull]]
/* filtered - setup call produces an object that's not used by the
test call, and doesn't mutate state */
#9124787 tutorial/Product.toString.( )Ljava/lang/String;
[[ref[tutorial.Product@170a650/notnull]]]
[ref[java.lang.String:“V-3496-55-F”]] Ex: [ref[NULL]]
/* the test call */
#16555646 tutorial/Product.toString.( )Ljava/lang/String;
[[ref[tutorial.Product@170a650/notnull]]]
[ref[java.lang.String:“V-3496-55-F”]] Ex: [ref[NULL]]

Given this sequence of operations and the corresponding test call, the final test that is generated looks like this:

```
public void testToString( ) throws Throwable {
    String result = new Product(“V-3496-55-F”).toString( );
    assertEquals(“result”, “V-3496-55-F”, result);
}
```

In some embodiments of the present invention, the final test from the filtering process is in a common language, instead of a more difficult to interpret proprietary language (which is used in some unit testing frameworks). For example, some embodiments of the present invention output the final test in the Java programming language.

After the filtering processes are completed on the operation sequence, the number of operations in the operation sequence has been reduced so the operation sequence can be run in a significantly reduced time (in comparison with the time required to run the original operation sequence). Although the operation sequence has been reduced, the verification process ensures that the outcome of the operation sequence matches the expected outcome (i.e., the outcome produced by the original operation sequence).

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for generating a test for a class under test, comprising:
receiving an operation sequence to be applied to the class under test;
generating one or more operation subsequences from the operation sequence;
filtering each operation subsequence; and
producing a filtered version of the operation subsequences, wherein the filtered version of the operating subsequences can be used to perform tests on the class under test more expediently.

2. The method of claim 1, wherein receiving the operation sequence involves receiving a sequence of operations generated from program code, wherein the sequence of operations includes operations performed on at least one path through the program code.

3. The method of claim 2, wherein receiving the operation sequence additionally involves preparing the operation sequence by:
recording operations in the operating sequence that are performed on the class under test as potential test calls;
instrumenting the class under test; and
executing the operation sequence and storing information related to each potential test call in a variable associated with the potential test call.

4. The method of claim 3, wherein instrumenting the class under test involves adding one or more calls to the class under test, wherein the calls record information related to execution of the class under test.

5. The method of claim 3, wherein generating one or more operation subsequences from the received operation sequence involves generating an operation subsequence for each potential test call, wherein each operation subsequence includes a copy of a set of operations between a start of the operation sequence and the corresponding potential test call.

6. The method of claim 5, wherein filtering each operation subsequence involves pre-filtering the operation subsequence by:
removing setup calls from the operating subsequence when the setup calls have undesirable effects on the potential test call;
removing unused objects;
removing unrelated objects;
removing operations that do not produce objects or alter state from the operation subsequence; and/or
removing intermediate states.

7. The method of claim 6, wherein after pre-filtering is completed, the method further comprises:
discarding operation subsequences that include more than a predetermined number of operations; and
for operation sequences that are not discarded, verifying that the potential test call at the end of the operating subsequence produces the same results as the information stored in the variable associated with the potential test call.

8. The method of claim 7, wherein the method further comprises discarding the operating subsequence if the potential test call at the end of the operating subsequence does not produce the same results.

9. The method of claim 7, wherein the method further comprises saving the operation subsequence as a unique operating subsequence if the potential test call at the end of the operating subsequence produces different but unique results, wherein the unique operating subsequence can subsequently be used as another test for the class under test.

10. The method of claim 7, wherein if the potential test call at the end of the operating subsequence produces the same results, the method further comprises post-filtering the operation subsequence by:
replacing with equivalent mock objects objects that cannot be constructed due to missing operations and/or objects of any class that has consistency problems due to timing or environmental dependencies from the subsequence;
removing unnecessary operations;
normalizing data and/or values and construction sequences; and/or
removing unnecessary instances of objects.

11. The method of claim 5, wherein filtering the operation subsequence involves post-filtering the operation subsequence by:
replacing with equivalent mock objects objects that cannot be constructed due to missing operations and/or objects of any class that has consistency problems due to timing or environmental dependencies from the subsequence;
removing unnecessary operations;
normalizing data and/or values and construction sequences; and/or
removing unnecessary instances of objects.

12. The method of claim 1, wherein producing the filtered version of the operating subsequences involves producing the filtered version of the operating subsequence in a common programming language.

13. The method of claim 1, further comprising performing the test on the class under test using the filtered operation subsequences.

14. A computer-readable storage medium, storing instructions that when executed by a computer cause the computer to perform a method for generating a test for a class under test, the method comprising:
receiving an operation sequence to be applied to the class under test;
generating one or more operation subsequences from the received operation sequence;
filtering each operation subsequence; and
producing a filtered version of the operation subsequences, wherein the filtered version of the operating subsequences can be used to perform tests on the class under test more expediently.

15. The computer-readable storage medium of claim 14, wherein receiving the operation sequence involves receiving a sequence of operations generated from program code, wherein the sequence of operations includes operations performed on at least one path through the program code.

16. The computer-readable storage medium of claim 15, wherein receiving the operation sequence additionally involves preparing the operation sequence by:
recording operations in the operating sequence that are performed on the class under test as potential test calls;
instrumenting the class under test; and
executing the operation sequence and storing information related to each potential test call in a variable associated with the potential test call.

17. The computer-readable storage medium of claim 16, wherein instrumenting the class under test involves adding one or more calls to the class under test, wherein the calls record information related to the execution of the class under test.

18. The computer-readable storage medium of claim 16, wherein generating one or more operation subsequences from the received operation sequence involves generating an operation subsequence for each potential test call, wherein each operation subsequence includes a copy of a set of operations between a start of the operation sequence and the corresponding potential test call.

19. The computer-readable storage medium of claim 18, wherein filtering each operation subsequence involves pre-filtering the operation subsequence by:
removing setup calls from the operating subsequence when the setup calls have undesirable effects on the potential test call;
removing unused objects;
removing unrelated objects;
removing operations that do not produce objects or alter state from the operation subsequence; and/or
removing intermediate states.

20. The computer-readable storage medium of claim 19, wherein after pre-filtering is completed, the method further comprises:
discarding operation subsequences that include more than a predetermined number of operations; and
for operation sequences that are not discarded, verifying that the potential test call at the end of the operating subsequence produces the same results as the information stored in the variable associated with the potential test call.

21. The computer-readable storage medium of claim 20, wherein the method further comprises discarding the operating subsequence if the operating subsequence does not produce the same results.

22. The computer-readable storage medium of claim 20, wherein the method further comprises saving the operation subsequence as a unique operating subsequence if the operating subsequence produces different but unique results, wherein the unique operating subsequence can subsequently be used as another test for the class under test.

23. The computer-readable storage medium of claim 20, wherein if the potential test call at the end of the operating subsequence produces the same results, the method further comprises post-filtering the operation subsequence by:
replacing with equivalent mock objects objects that cannot be constructed due to missing operations and/or objects of any class that has consistency problems due to timing or environmental dependencies from the subsequence;
removing unnecessary operations;
normalizing data and/or values and construction sequences; and/or
removing unnecessary instances of objects.

24. The computer-readable storage medium of claim 18, wherein filtering the operation subsequence involves post-filtering the operation subsequence by:
replacing with equivalent mock objects objects that cannot be constructed due to missing operations and/or objects of any class that has consistency problems due to timing or environmental dependencies from the subsequence;
removing unnecessary operations;
normalizing data and/or values and construction sequences; and/or
removing unnecessary instances of objects.

25. The computer-readable storage medium of claim 14, wherein producing the filtered version of the operating subsequences involves producing the filtered version of the operating subsequence in a common programming language.

26. The computer-readable storage medium of claim 14, further comprising performing the test on the class under test using the filtered operation subsequences.

27. An apparatus for generating a test for a class under test, comprising:
a processor;
a memory coupled to the processor, wherein the memory stores instructions and data for the processor;
an execution mechanism on the processor, wherein the execution mechanism is configured to
receive an operation sequence to be applied to the class under test;
generate one or more operation subsequences from the received operation sequence;
filter each operation subsequence; and
produce a filtered version of the operation subsequences, wherein the filtered version of the operating subsequences can be used to perform tests on the class under test more expediently.

28. The apparatus of claim 27, wherein when receiving the operation sequence, the execution mechanism is configured to receive a sequence of operations generated from program code, wherein the sequence of operations includes operations performed on at least one path through the program code.

29. The apparatus of claim 28, wherein when receiving the operation sequence, the execution mechanism is further configured to prepare the operation sequence by:
recording operations in the operating sequence that are performed on the class under test as potential test calls;
instrumenting the class under test; and
executing the operation sequence and storing information related to each potential test call in a variable associated with the potential test call.

30. The apparatus of claim 29, wherein when instrumenting the class under test, the execution mechanism is configured to add one or more calls to the class under test, wherein the calls record information related to the execution of the class under test.

31. The apparatus of claim 29, wherein when generating one or more operation subsequences from the received operation sequence, the execution mechanism is configured to generate an operation subsequence for each potential test call, wherein each operation subsequence includes a copy of a set of operations between a start of the operation sequence and the corresponding potential test call.

32. The apparatus of claim 31, wherein when filtering each operation subsequence, the execution mechanism is configured to pre-filter the operation subsequence by:
removing setup calls from the operating subsequence when the setup calls have undesirable effects on the potential test call;
removing unused objects;
removing unrelated objects;
removing operations that do not produce objects or alter state from the operation subsequence; and/or
removing intermediate states.

33. The apparatus of claim 32, wherein after pre-filtering is completed, the execution mechanism is configured to:
discard operation subsequences that include more than a predetermined number of operations; and
for operation sequences that are not discarded, verify that the potential test call at the end of the operating subsequence produces the same results as the information stored in the variable associated with the potential test call.

34. The apparatus of claim 33, wherein the execution mechanism is configured to discard the operating subsequence if the potential test call at the end of the operating subsequence does not produce the same results.

35. The apparatus of claim 33, wherein the execution mechanism is configured to save the operation subsequence as a unique operating subsequence if the potential test call at the end of the operating subsequence produces different but unique results, wherein the unique operating subsequence can subsequently be used as another test for the class under test.

36. The apparatus of claim 33, wherein if the potential test call at the end of the operating subsequence produces the same results, the execution mechanism is configured to post-filter the operation subsequence by:
replacing with equivalent mock objects objects that cannot be constructed due to missing operations and/or objects of any class that has consistency problems due to timing or environmental dependencies from the subsequence;
removing unnecessary operations;
normalizing data and/or values and construction sequences; and/or
removing unnecessary instances of objects.

37. The apparatus of claim 31, wherein when filtering the operation subsequence, the execution mechanism is configured to post-filter the operation subsequence by:
replacing with equivalent mock objects objects that cannot be constructed due to missing operations and/or objects of any class that has consistency problems due to timing or environmental dependencies from the subsequence;
removing unnecessary operations;
normalizing data and/or values and construction sequences; and/or
removing unnecessary instances of objects.

38. The apparatus of claim 27, wherein when producing the filtered version of the operating subsequences, the execution mechanism is configured to produce the filtered version of the operating subsequence in a common programming language.

39. The apparatus of claim 27, wherein the execution mechanism is configured to perform the test on the class under test using the filtered operation subsequences.
